(19) United States
(12) Patent Application Publication
(10) Pub. No.: US 2002/0075515 A1
(43) Pub. Date: Jun. 20, 2002

(54) Process for making a front panel of a scoreboard

(76) Inventor: Brent D. Peterson, Brookings, SD (US)

Correspondence Address: Hugh D. Jaeger, Suite 302, 1000 Superior Blvd., Wayzata, MN, 55391-1873, US

(21) Appl. No.: 09/739,521

(22) Filed: Dec. 15, 2000

(51) Int. Cl. G06F 15/00; B41J 1/00

(52) U.S. Cl. 358/1.18; 358/1.15

(57) ABSTRACT

A process for making a front panel of a scoreboard by computer generating a layout and color scheme incorporating lettering and graphics and digitally printing the layout directly onto a front panel made of vinyl, or other appropriate material. The front panel is then appropriately secured to the body of a scoreboard. This method allows the user to easily add a custom look to a generic scoreboard in a one-step process.

### CROSS REFERENCES TO CO-PENDING APPLICATIONS

None.

### BACKGROUND OF THE INVENTION

1. Field of the Invention

The present invention is for a process for making a front panel of a scoreboard.

2. Description of the Prior Art

The current practice for labeling a scoreboard is to apply all striping, captions and graphics individually. This is accomplished by painting the scoreboard front surface a desired color and then adding striping, captions and graphics by either painting or by cutting individual letters out of vinyl, or other appropriate material, and affixing them to the painted scoreboard. This not only is a time-consuming procedure, but also is an ineffective procedure because often the individual letters are applied crooked or are improperly aligned.

To overcome the shortcomings of the current practice, a sheet of vinyl, or other appropriate material, is printed with all of the needed striping, captions and graphics, and then is applied in one step to the entire face of the scoreboard. This process allows the lettering to be any color or combination of colors, and the vinyl sheet itself can be given any desired background color. This process also allows for intricate, multicolor graphics to be easily applied directly onto the vinyl sheet.

### SUMMARY OF THE INVENTION

The general purpose of the present invention is to provide an improved process for making a front panel of a scoreboard.

According to one embodiment of the present invention, there is provided a vinyl sheet, including computer generated striping, captions, graphics and background coloring which is printed directly on the vinyl sheet. The vinyl sheet is then appropriately secured to the entire face of a standard scoreboard. This process allows for unlimited color combinations, intricate graphics, shading and/or shadowing, thereby creating a custom look to a traditionally generic scoreboard.

One significant aspect and feature of the present invention is a vinyl sheet on which striping, lettering and graphics are directly applied.

Another significant aspect and feature of the present invention is the ability to use unlimited color combinations.

Still another significant aspect and feature of the present invention is the ability to easily add intricate graphics to the face of a scoreboard.

Yet another significant aspect and feature of the present invention is the elimination of the painting process which is typically time-consuming and laborious.

A further significant aspect and feature of the present invention is the ability to apply all the graphics lettering, striping, and background color in one step.

A still further significant aspect and feature of the present invention is the ability to scan virtually any image in any color into a computer where layout can be configured.

Having thus enumerated significant aspects and features of the present invention and described an embodiment of the present invention, it is the principal object of the present invention to provide a process for making a front panel of a scoreboard.

One object of the present invention is to provide a means to print lettering, striping and graphics directly on the front panel of a scoreboard in one step.

Another object of the present invention is to provide a means to align and configure all the lettering and graphics on a computer before printing them directly on a vinyl front panel.

Yet another object of the present invention is to provide a means to easily incorporate intricate graphics onto the front panel of a scoreboard.

Still another object of the present invention is to provide quick and easy application of the entire front panel of a scoreboard in one step.

A further object of the present invention is to provide a means to eliminate the need to individually apply each letter or graphic on the face of a scoreboard.

A still further object of the present invention is to eliminate the time-consuming process of manually painting the components of a scoreboard.

### BRIEF DESCRIPTION OF THE DRAWINGS

Other objects of the present invention and many of the attendant advantages of the present invention will be readily appreciated as the same becomes better understood by reference to the following detailed description when considered in connection with the accompanying drawings, in which like reference numerals designate like parts throughout the figures thereof and wherein:

FIG. 1 illustrates an isometric view of a complete scoreboard, the present invention; and,

FIG. 2 illustrates an exploded view of the scoreboard.

### DETAILED DESCRIPTION OF THE PREFERRED EMBODIMENT

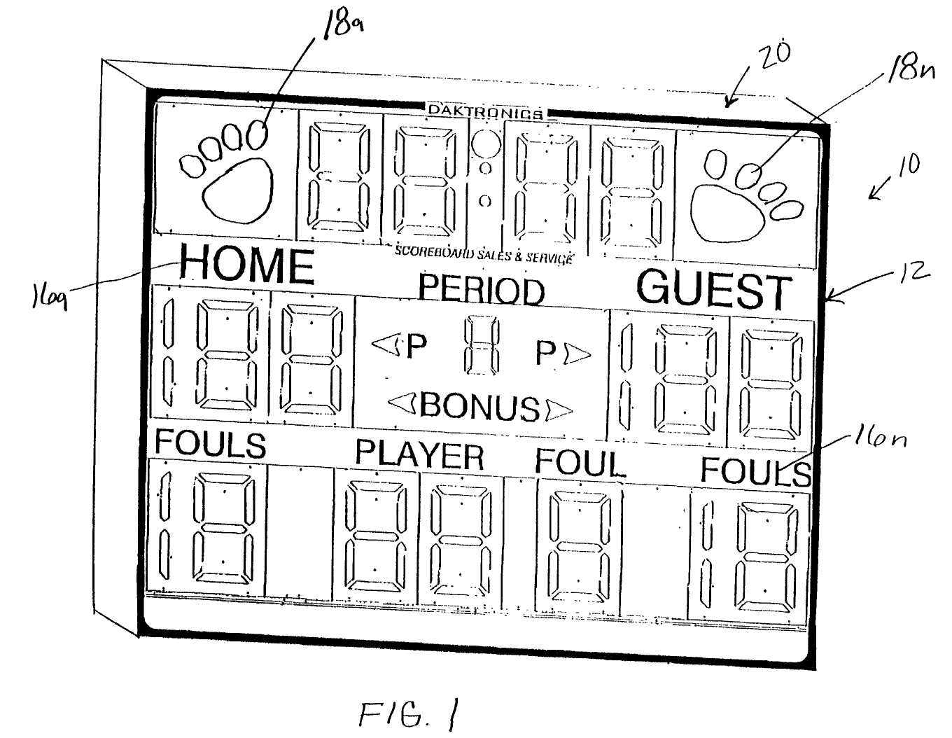

FIG. 1 illustrates an isometric view of a complete scoreboard 10 incorporating a one-piece front panel 12, the present invention. The scoreboard front panel 12 is created by selecting and formatting a plurality of captions 16a-16n and a plurality of graphics 18a-18n in any color in the desired layout which is input into a computer. Once the desired layout is achieved in the computer, the one-piece front panel 12, made of vinyl film or other appropriate material, is loaded into a digital printer where the captions, graphics, and background color are printed directly onto the front panel 12. Typically, the front panel 12 has a pull-away backing, which when removed exposes an adhesive material for applying the front panel 12 onto the scoreboard body 20. It is to be understood that the front panel 12 may be appropriately secured to the scoreboard body 20 by any other appropriate means. This method provides a one-step application of all the captions 16a-16n, graphics 18a-18n, and background color to a scoreboard 10.

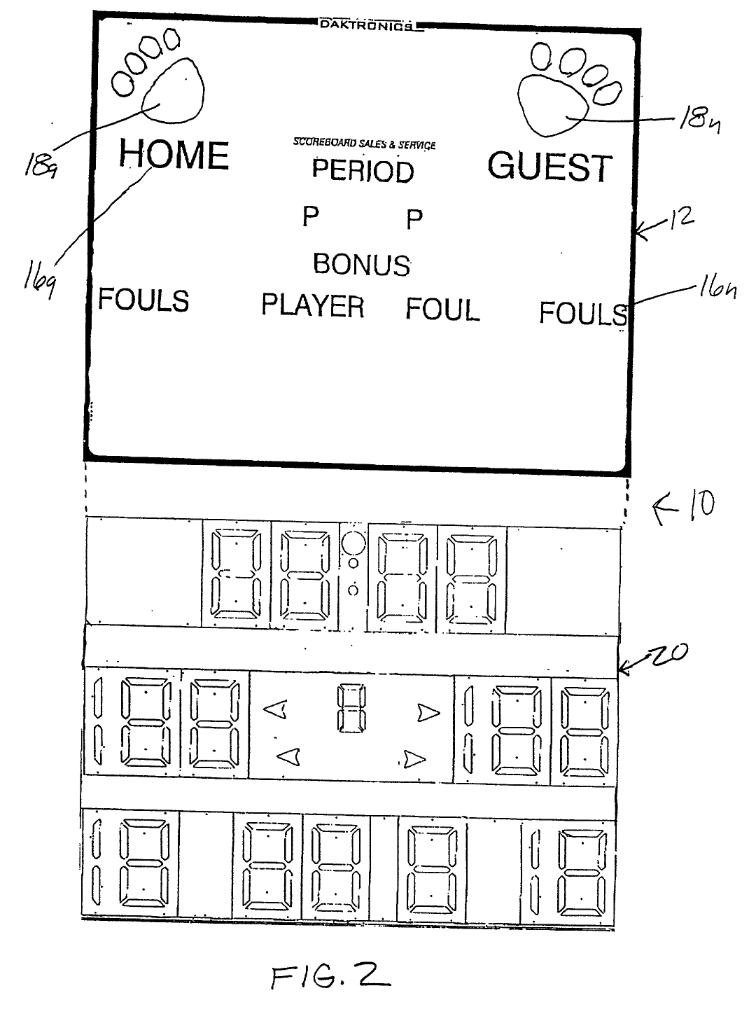

FIG. 2 illustrates an exploded view of a scoreboard 10, where all numerals correspond to those elements previously described. Illustrated in particular is front panel 12 removed from scoreboard body 20, which allows the user the ability to take a standard, generic scoreboard body 20 and enhance its appearance with multicolor captions 16a-16n and graphics 18a-18n which are printed directly on the front panel 12. The present invention creates a new method of creating custom scoreboards without the time-consuming processes of manually painting and manually applying each letter of each caption on the front panel, greatly reducing the possibility of misalignment or error.

Various modifications can be made to the present invention without departing from the apparent scope hereof.

It is claimed:

1. A process for making a front panel of a scoreboard comprising the steps of,
a. selecting from a group consisting of numerals, words, and graphics for a front panel of a scoreboard;
b. formatting said selection;
c. inputting said selection into a computer;
d. loading a sheet of film with a pull-away backing into a digital printer connected to said computer;
e. printing said selection onto said film;
f. removing said pull-away backing from said film; and,
g. applying said film to a front face of a scoreboard.

2. A process for making a front panel of a scoreboard comprising the steps of,
a. selecting from a group consisting of numerals, words, and graphics for a front panel of a scoreboard;
b. formatting said selection;
c. inputting said selection into a computer;
d. loading a sheet of film into a digital printer connected to said computer;
e. printing said selection onto said film;
f. removing said film from said printer; and,
g. applying said film to a front face of a scoreboard.
